(19) United States
(12) Patent Application Publication
(10) Pub. No.: US 2010/0036524 A1
(43) Pub. Date: Feb. 11, 2010

(54) Method and Apparatus for Converting a Gift Card into a Generic Prepaid Credit Card

(76) Inventor: Paul T. Chirco, Shelby Township, MI (US)

Correspondence Address: GREGORY T. ZALECKI, 12900 HALL ROAD, SUITE 400, STERLING HEIGHTS, MI, 48313, US

(21) Appl. No.: 12/188,806

(22) Filed: Aug. 8, 2008

(51) Int. Cl. G07F 7/12; G07F 7/08

(52) U.S. Cl. 700/237; 700/232

(57) ABSTRACT

An apparatus for converting a gift card into a generic prepaid credit card is comprised of a gift card reader, a data input device, a data output device, a telecommunications device and a prepaid credit card production device, all operatively connected to a computer. The telecommunications device permits communication between the apparatus, the gift card vendor and the generic prepaid credit card vendor. The computer is programmed such that when a gift card is inserted into the reader its value is determined and, after the deduction of transaction fees, the monetary value is transferred to a generic prepaid credit card which is dispensed to the customer. The method for converting a gift card into a generic prepaid credit card which is implemented by the apparatus is also a part of this invention.

### BACKGROUND

Gift cards have become popular gift items. A typical gift card is issued by a store or a restaurant. It is in the shape of a credit card and contains magnetically encoded data. The data is readable by a gift card reader. It contains a monetary value. The data may also contain information identifying the gift card vendor. Alternatively, the monetary value associated with the gift card may be stored upon a remote computer maintained by the gift card vendor. Most gift cards can be used at a single chain of stores or restaurants. Typically, gift cards cannot be used outside of the issuing chain, or outside of a limited number of chains. For example, if a gift card was issued by a store within chain X that card can only be used at stores which are within chain X. In order to use a gift card a purchase is made and a gift card is presented for payment of the purchase. The vendor of the purchase determines the value on the gift card by swiping it through a gift card reader. The gift card reader determines that there is a sufficient balance on the gift card to make the purchase. After the purchase, the monetary value encoded upon the gift card is reduced to reflect the purchase. Alternatively, the monetary value associated with the gift card is reduced on a remote computer maintained by the gift card vendor.

The fact that most gift cards can be used only within a specific issuing chain of stores or restaurants can present problems to gift card holders. A person may have received a gift card that is usable only within a chain of stores or restaurants where that person does not desire to make a purchase. For example, a person may have received a gift card as a gift which is only valid in a chain of sporting goods stores when that person has no interest in purchasing sporting goods. Or, the person may have received a gift card as a gift which is only valid in a chain of restaurants when that person has no interest in eating at any restaurant within that chain. Although a person may have received a gift card for a store or restaurant in which that person has no interest, others would often welcome a gift card to that store or restaurant. After a purchase is made with a gift card the monetary balance associated with the gift card may be reduced to a value which is low enough that the gift card holder would not want to use that gift card again.

Gift cards are limited to a narrow choice of stores or restaurants. The holder of a gift card would often welcome the opportunity to use that gift card outside of that narrow choice of stores or restaurants. This can be accomplished by converting the gift card into a generic prepaid credit card. There is a need for a method and apparatus for converting a gift card into a generic prepaid credit card.

### SUMMARY

This need is satisfied by the method and apparatus for converting a gift card into a generic prepaid credit card described herein.

An apparatus for converting a gift card into a generic prepaid credit card is comprised of a gift card reader, a data input device, a data output device, a telecommunications device, a generic prepaid credit card production device and a programmable computer.

The gift card reader reads the monetary balance on a gift card. Alternatively, data on the gift card read by the gift card reader is used to retrieve the monetary balance associated with the gift card from a remote computer maintained by the gift card vendor. The reader is a device which allows a credit card sized gift card with a magnetically encoded strip to be swiped through it and have its magnetic encodings read.

The data input device may be a keypad. It is used to receive input identifying the gift card vendor and for communications between a customer and the apparatus.

The data output device provides information to the user. It may be an LCD (liquid crystal display) display.

The telecommunications device is adapted to provide bidirectional transfer of data between the apparatus and a computer maintained by a gift card vendor. It is also adapted to provide bidirectional transfer of data between the apparatus and a computer maintained by a generic prepaid credit card vendor.

The data input device, the data output device and the telecommunications device are optional, but preferred, components of the apparatus.

The generic prepaid credit card production device is adapted to produce and dispense a generic prepaid credit card.

The computer of the apparatus is operatively connected to the gift card reader, the data input device, the data output device, the telecommunications device and the generic prepaid credit card production device. The computer of the apparatus is programmed to read data on a gift card inserted into the gift card reader, to communicate data received from the data input device and the gift card reader to the vendor of the gift card inserted into the gift card reader through the telecommunications device, to receive verification of the gift card balance from the vendor of the gift card, to determine transaction fees to be paid to the generic prepaid credit card vendor, to determine transaction fees to be paid to the gift card vendor, to determine transaction fees assessed for use of the apparatus, to determine the monetary balance of the generic prepaid credit card, to communicate the amount of the transaction fees and the monetary balance of the generic prepaid credit card to the generic prepaid credit card vendor through the telecommunications device, to communicate information regarding the transaction to the gift card vendor through the telecommunications device, to produce a generic prepaid credit card with the determined monetary balance, to dispense the generic prepaid credit card, and to display the status of the conversion process to the user of the apparatus.

Preferably, the gift card reader is adapted to read data identifying the gift card vendor from the gift card and the data input device is adapted to receive data identifying the user. If the generic prepaid credit card production device is adapted to emboss data identifying the user upon the generic prepaid credit card, the embossed data identifying the user would be provided by the user through the data input device.

The computer of the apparatus may also be programmed to read data on a plurality of gift cards inserted into the gift card reader by a single user, to communicate data received from the gift card reader to the vendor of each gift card inserted into the gift card reader by the single user through the telecommunications device, to receive verification of the gift card balance from the vendor of each gift card inserted into the gift card reader by the single user through the telecommunications device, to determine transaction fees to be paid to the vendor of each gift card inserted into the gift card reader by the single user, to determine the monetary balance of the generic prepaid credit card based upon the gift card balance of each gift card inserted into the gift card reader by the single user, and to communicate information regarding the transaction to the vendor of each gift card inserted into the gift card reader by the single user. This will allow a user to sequentially insert multiple gift cards into the apparatus and have the monetary values of those gift cards combined into one monetary value on a generic prepaid credit card.

The invention described herein also includes a method for converting a gift card into a generic prepaid credit card. The method consists of the following steps:
determining the identity of the vendor of the gift card;
reading the monetary balance of the gift card (directly from the gift card or, indirectly, from a database maintained by the gift card vendor) with a gift card reader;
displaying the monetary balance of the gift card on a visual display device;
verifying that the owner of the gift card desires to complete the conversion;
producing and dispensing a generic prepaid credit card having a monetary value which is based upon the monetary balance of the gift card; and
optionally, reporting the monetary value of the generic prepaid credit card to the vendor of the generic prepaid credit card and reporting a monetary balance reduction of the gift card to the gift card vendor.
   Preferably, the method also consists of the following steps:
determining transaction fees to be paid to the generic prepaid credit card vendor;
determining transaction fees to be paid to the gift card vendor;
determining transaction fees to be assessed for the conversion process;
communicating the amount of the transaction fees to be paid to the generic prepaid credit card vendor and the monetary balance of the generic prepaid credit card to the generic prepaid credit card vendor through a telecommunications device; and
communicating information regarding the transaction to the gift card vendor through a telecommunications device.

The identity of the vendor of a gift card may be determined by reading data from a data input device. In this case the user inputs the identity data with the input device. Alternatively, the identity of the vendor may be determined by reading the data encoded on the gift card.

### DRAWINGS

These and other features, aspects, and advantages of the present invention will become better understood with regard to the following description, appended claims, and accompanying drawings where:

FIG. 1 is a perspective view of an apparatus for converting a gift card into a generic prepaid credit card.

FIG. 2 is a front elevational view of the apparatus for converting a gift card into a generic prepaid credit card of FIG. 1.

### DESCRIPTION

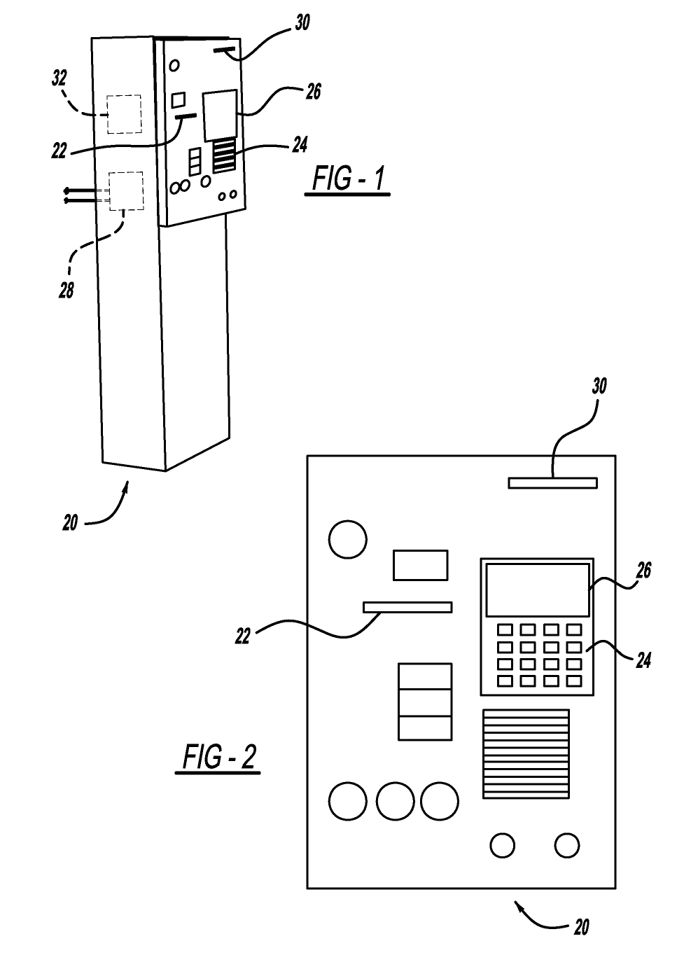

A preferred embodiment of an apparatus 20 for converting a gift card into a generic prepaid credit card is shown in FIG. 1 and FIG. 2.

A typical gift card is issued by a store or a restaurant. It is in the shape of a credit card and contains magnetically encoded data. The data is readable by a gift card reader. It typically contains a monetary value. Alternatively, the magnetically encoded data may be used to retrieve the monetary value associated with the gift card from a remote computer maintained by the gift card vendor. The data may also contain information identifying the gift card vendor. Most gift cards can be used at a single chain of stores or restaurants. Stores and restaurants currently issuing gift cards include: Lowe's, Home Depot, Target, Best Buy, Costco, Nordstrom, Pottery Barn, Olive Garden, Outback Steakhouse, Barnes & Noble and Red Lobster. Typically, gift cards cannot be used outside of the issuing chain or outside of a limited number of chains. For example, if a gift card was issued by a store within chain X that card can only be used at stores which are within chain X. In order to use a gift card a purchase is made and a gift card is presented for payment of the purchase. The vendor of the purchase determines the value on the gift card by swiping it through a gift card reader. The gift card reader determines (directly or indirectly) that there is a sufficient balance on the gift card to make the purchase. After the purchase the encoded monetary value on the gift card is reduced by the amount of the purchase or, in the alternative, the new monetary value of the gift card is transmitted to a remote computer storage device maintained by the gift card vendor.

Generic prepaid credit cards are issued by credit card companies such as Visa and Discover. Generic prepaid credit cards can be used at almost all locations where credit cards issued by the issuer can be used. Thus they can be used at many more locations compared to the gift cards previously described. Generic prepaid credit cards are prepaid cards also known as prepaid stored value cards. When they are issued they are associated with a specific monetary value. The user uses a generic prepaid credit card as a traditional credit card such as a Visa credit card or a Discover credit card. Optionally, user identifying information is associated with a generic prepaid credit card. This identifying information includes the user's name and address. This makes it possible for a generic prepaid credit card to be used to make online purchases and telephone purchases. Most online sellers and telephone sellers required the buyer to provide the billing name and billing address associated with a credit card. Often such sellers will only ship merchandise to the registered billing address. Generic prepaid credit cards can be issued with or without associated owner identifying information such as name and address. Most generic prepaid credit card issuers have a post purchase registration procedure which allows the owner to associate his or her identifying information with the card.

The preferred apparatus 20 is comprised of a gift card reader 22, a data input device 24, a data output device 26, a telecommunications device 28, a generic prepaid credit card production device 30 and a computer 32. These components may be combined into a kiosk adapted to be located in a shopping mall.

The gift card reader 22 is a card reader adapted to read encoded data on a gift card. Typically, the encoded data is contained within a magnetic strip on the card. The data typically includes the monetary balance of the gift card. The data may also include data identifying the gift card vendor. For example, if the gift card vendor was Home Depot, the data on the gift card would identify the issuer as Home Depot. The most common gift card readers read information encoded within a magnetic strip on the gift card when the gift card is swiped through the gift card reader. The gift card reader should also be capable of reencoding the monetary value on the gift card to reflect a reduction in the original monetary value in the amount of a purchase. Some gift card vendors may maintain the monetary balance of a gift card on a remote computer server. In this case the data contained on the gift card is sufficient to retrieve the gift card balance data from the remote computer server.

The data input device 24 receives input data from the user. The input data should include data identifying the gift card vendor. The data input may also include data identifying the user. The user identifying data can be used by the generic prepaid credit card issuer to associate user identifying information with the generic prepaid credit card. For example, the user's name and address may be associated with the generic prepaid credit card. The preferred data input device 24 is a keypad. Other types of data input devices may also be used. These include touchpad display screens, light pens and computer mice. The data input device 24 is an optional, but preferred, component of the apparatus 20.

The data output device 26 is adapted to provide information to the user. It may be a CRT (cathode ray tube) or an LCD (liquid crystal display) capable of displaying information. The data output device 26 is an optional, but preferred, component of the apparatus 20.

The telecommunications device 28 is adapted to provide for the transfer of data between the apparatus 20 and one or more remote computers. One remote computer would be a computer maintained by the gift card vendor. Optionally, the telecommunications device 28 may provide for the transfer of data between the apparatus 20 and a remote computer maintained by the generic prepaid credit card vendor. The telecommunications device 28 is an optional, but preferred, component of the apparatus 20. The telecommunications device 28 may be a computer modem or computer network adapter.

The generic prepaid credit card production device 30 is adapted to produce and dispense a generic prepaid credit card. It is a device capable of encoding information upon the generic prepaid credit card. For example, it may magnetically encode a monetary value upon a magnetic strip on the generic prepaid credit card. It may also encode other data upon the generic prepaid credit card such as user identifying information (name and address) and generic prepaid credit card issuer information (i.e. Visa or Discover identifying information). The generic prepaid credit card production device may be loaded with a plurality of generic prepaid credit cards for later encoding and dispensation. The ultimate objective of the generic prepaid credit card production device 30 is to dispense a generic prepaid credit card, such as a Visa card or a Discover card, to a user. The generic prepaid credit card production device 30 may also be adapted to emboss data identifying the user, such as the user's name, upon the generic prepaid credit card. The generic prepaid credit card device 30 may also be adapted to dispense generic prepaid credit cards having fixed pre-encoded monetary values.

The computer 32 is operatively connected to the gift card reader 22 and the generic prepaid credit card production device 30. Optionally, it is operatively connected to a data input device 24, a data output device 26 and/or a telecommunications device 28. The operative connections can be electrical connections implemented by printed circuit board (PCB) tracings, data and power cables, or PCB cards inserted into slots.

The computer 32 of the apparatus 20 is programmed to read data on a gift card inserted into the gift card reader 22, to determine the monetary balance of the generic prepaid credit card which is to be dispensed, to produce a generic prepaid credit card with the determined monetary balance and to dispense the generic prepaid credit card. Preferably, the computer 32 is also programmed to communicate data received from the data input device 24 and/or the gift card reader 22 to the vendor of the gift card inserted into the gift card reader 22 through the telecommunications device 28, to receive verification of the gift card balance from the vendor of the gift card, to determine transaction fees to be paid to the generic prepaid credit card vendor, to determine transaction fees to be paid to the gift card vendor, to determine transaction fees assessed for use of the apparatus 20, to communicate the amount of the transaction fees and the monetary balance of the generic prepaid credit card to the generic prepaid credit card vendor through the telecommunications device 28, to communicate information regarding the transaction to the gift card vendor through the telecommunications device 28, and to display the status of the conversion process to the user of the apparatus 20.

Transaction fees are intended to provide an incentive to gift card vendors and generic prepaid credit card vendors to participate in the conversion of gift cards into generic prepaid credit cards. Without these transaction fees gift card vendors and generic prepaid credit card vendors may not be interested in participating in the conversion process. The transaction fees are deducted from the monetary balance of a gift card in order to determine the monetary balance of the generic prepaid credit card to be issued. For example, if the monetary balance on a gift card is $100 and the transaction fees amount to $5, a monetary balance on the generic prepaid credit card to be issued would be $95. The $5 in transaction fees would be apportioned to the gift card vendor, the generic prepaid credit card vendor and the owner/operator of the apparatus 20. $1 of the $5 transaction fees would be paid to the generic prepaid credit card vendor (e.g. Visa). $1 of the $5 transaction fees would be paid to the gift card vendor (e.g. Target stores). $3 of the $5 transaction fees would be paid to the owner/operator of the apparatus 20. The remaining monetary balance ($95) of the original $100 monetary balance on the gift card would be transferred as a $95 monetary balance on the generic prepaid credit card.

The apparatus 20 may be set up so that a user may insert a plurality of gift cards into the gift card reader in order to combine all gift card monetary values into one monetary value on one generic prepaid credit card. The computer 32 of the apparatus 20 would be programmed to read data on a plurality of gift cards inserted into the gift card reader 22 by a single user, to communicate data received from the gift card reader 22 to the vendor of each gift card inserted into the gift card reader by the single user through the telecommunications device 28, to receive verification of the gift card balance from the vendor of each gift card inserted into the gift card reader 22 by the single user through the telecommunications device 28, to determine transaction fees to be paid to the vendor of each gift card inserted into the gift card reader 22 by the single user, to determine the monetary balance of the generic prepaid credit card based upon the gift card balance of each gift card inserted into the gift card reader 22 by the single user, and to communicate information regarding the transaction to the vendor of each gift card inserted into the gift card reader 22 by the single user.

A typical embodiment of an apparatus 20 for converting a gift card into a generic credit card is used as follows. A customer inserts a gift card from any participating retailer into the gift card reader 22. The customer punches in his or her name and the retailer's name on a keypad comprising the data input device 24. The gift card reader 22 scans the gift card. The apparatus 20 checks the gift card balance and displays the balance on the data output device 26. The customer okays the balance and instructs the apparatus 20 to complete the exchange by inputting a selection on the data input device (keypad) 24. Transaction fees are deducted from the gift card. A portion of the transaction fees is allocated to the generic prepaid credit card vendor (e.g. Visa). A portion of the transaction fees is allocated to the gift card vendor (e.g. Target stores). The remainder of the transaction fees are allocated to the owner/operator of the apparatus 20. A generic prepaid credit card (e.g. Visa card) with a monetary balance determined by subtracting the transaction fees from the monetary value of the gift card is dispensed from the apparatus 20. Appropriate debit and credit accounting entries are communicated to the generic prepaid credit card vendor and the gift card vendor. The customer can now use the generic prepaid credit card (e.g. Visa card) to make purchases from most retail outlets, stores and restaurants. When the generic prepaid credit card is used to make a purchase from a retailer, the retailer submits the transaction details to the generic prepaid credit card vendor to be processed in a manner similar to the processing of a credit card transaction.

The invention described herein also includes a method for converting a gift card into a generic prepaid credit card. The method consists of the following steps:
determining the identity of the vendor of the gift card;
reading the monetary balance of the gift card with a gift card reader 22 (directly, or, indirectly by communicating with a remote computer maintained by the gift card vendor);
displaying the monetary balance of the gift card on a visual display device 26;
verifying that the owner of the gift card desires to complete the conversion;
producing and dispensing a generic prepaid credit card having a monetary value which is based upon the monetary balance of the gift card; and
optionally, reporting the monetary value of the generic prepaid credit card to the vendor of the generic prepaid credit card and reporting a monetary balance reduction of the gift card to the gift card vendor.
   Preferably, the method also consists of the following steps:
determining transaction fees to be paid to the generic prepaid credit card vendor;
determining transaction fees to be paid to the gift card vendor;
determining transaction fees to be assessed for the conversion process;
communicating the amount of the transaction fees to be paid to the generic prepaid credit card vendor and the monetary balance of the generic prepaid credit card to the generic prepaid credit card vendor through a telecommunications device 28; and
communicating information regarding the transaction to the gift card vendor through a telecommunications device 28.

The identity of the vendor of a gift card may be determined by reading data from a data input device 24. In this case the user inputs the identity data with the input device 24. Alternatively, the identity of the vendor may be determined by reading the data encoded on the gift card.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. An apparatus for converting a gift card into a generic prepaid credit card, said apparatus comprising:
(a) a gift card reader;
(b) a generic prepaid credit card production device for producing and dispensing a generic prepaid credit card; and
(c) a computer operatively connected to the gift card reader and the generic prepaid credit card production device;
(d) said computer of the apparatus being programmed to read data on a gift card inserted into the gift card reader, to determine the monetary balance of the generic prepaid credit card, to produce a generic prepaid credit card with the determined monetary balance, and to dispense the generic prepaid credit card.

2. The apparatus of claim 1, further comprising a data input device for receiving data identifying the gift card vendor, wherein the computer is operatively connected to the data input device and is further programmed to receive data from the data input device identifying a gift card vendor.

3. The apparatus of claim 2, wherein the input device is adapted to receive data identifying the user and the computer of the apparatus is further programmed to receive the data identifying the user from the input device.

4. The apparatus of claim 1, further comprising a data output device for providing information to the user, wherein the computer is operatively connected to the data output device and is further programmed to display the status of the conversion process to the user of the apparatus.

5. The apparatus of claim 1, further comprising a telecommunications device for the transfer of data between the apparatus and a remote computer, said telecommunications device being operatively connected to the computer of the apparatus, wherein the computer of the apparatus is further programmed to communicate data received from the gift card reader to the remote computer.

6. The apparatus of claim 5, wherein the computer of the apparatus is further programmed to receive verification of the gift card balance from the remote computer.

7. The apparatus of claim 5, wherein the computer of the apparatus is further programmed to determine transaction fees to be paid to a generic prepaid credit card vendor, to determine transaction fees to be paid to a gift card vendor, to determine transaction fees to be assessed for the use of the apparatus, to communicate the amount of the transaction fees and the monetary balance of the generic prepaid credit card to the generic prepaid credit card vendor through the telecommunications device, and to communicate information regarding the transaction to the gift card vendor through the telecommunications device.

8. The apparatus of claim 5, further comprising a data output device for providing information to the user, wherein the computer is operatively connected to the data output device and wherein the computer of the apparatus is further programmed to display the gift card balance.

9. An apparatus for converting a gift card into a generic prepaid credit card, said apparatus comprising:
(a) a gift card reader;
(b) a data input device for receiving data identifying the gift card vendor;
(c) a data output device for providing information to the user;
(d) a telecommunications device for bidirectional transfer of data between the apparatus and a computer maintained by the gift card vendor and for bidirectional transfer of data between the apparatus and a computer maintained by a generic prepaid credit card vendor;
(e) a generic prepaid credit card production device for producing and dispensing a generic prepaid credit card; and
(f) a computer operatively connected to the gift card reader, the data input device, the data output device, the telecommunications device and the generic prepaid credit card production device;
(g) said computer of the apparatus being programmed to read data on a gift card inserted into the gift card reader, to communicate data received from the data input device and the gift card reader to the vendor of the gift card inserted into the gift card reader through the telecommunications device, to receive verification of the gift card balance from the vendor of the gift card, to determine transaction fees to be paid to the generic prepaid credit card vendor, to determine transaction fees to be paid to the gift card vendor, to determine transaction fees assessed for use of the apparatus, to determine the monetary balance of the generic prepaid credit card, to communicate the amount of the transaction fees and the monetary balance of the generic prepaid credit card to the generic prepaid credit card vendor through the telecommunications device, to communicate information regarding the transaction to the gift card vendor through the telecommunications device, to produce a generic prepaid credit card with the determined monetary balance, to dispense the generic prepaid credit card, and to display the status of the conversion process to the user of the apparatus.

10. The apparatus of claim 9, wherein the gift card reader is adapted to read data identifying the gift card vendor from the gift card and the data input device is adapted to receive data identifying the user.

11. The apparatus of claim 9, wherein the generic prepaid credit card production device is adapted to emboss data identifying the user upon the generic prepaid credit card.

12. The apparatus of claim 9, wherein the computer of the apparatus is programmed to read data on a plurality of gift cards inserted into the gift card reader by a single user, to communicate data received from the gift card reader to the vendor of each gift card inserted into the gift card reader by the single user through the telecommunications device, to receive verification of the gift card balance from the vendor of each gift card inserted into the gift card reader by the single user through the telecommunications device, to determine transaction fees to be paid to the vendor of each gift card inserted into the gift card reader by the single user, to determine the monetary balance of the generic prepaid credit card based upon the gift card balance of each gift card inserted into the gift card reader by the single user, and to communicate information regarding the transaction to the vendor of each gift card inserted into the gift card reader by the single user.

13. A method for converting a gift card into a generic prepaid credit card, said method comprising the steps of:
(a) determining the identity of the vendor of the gift card;
(b) reading the monetary balance of the gift card with a gift card reader;
(c) displaying the monetary balance of the gift card on a visual display device;
(d) verifying that the owner of the gift card desires to complete the conversion; and
(e) producing and dispensing a generic prepaid credit card having a monetary value which is based upon the monetary balance of the gift card.

14. The method for converting a gift card into a generic prepaid credit card of claim 13, wherein the identity of the vendor of the gift card is determined by reading data from a data input device.

15. The method for converting a gift card into a generic prepaid credit card of claim 13, further comprising the steps of:
(a) determining transaction fees to be paid to the generic prepaid credit card vendor;
(b) determining transaction fees to be paid to the gift card vendor;
(c) determining transaction fees to be assessed for the conversion process;
(d) communicating the amount of the transaction fees to be paid to the generic prepaid credit card vendor and the monetary balance of the generic prepaid credit card to the generic prepaid credit card vendor through a telecommunications device; and
(e) communicating information regarding the transaction to the gift card vendor through a telecommunications device.

16. The method for converting a gift card into a generic prepaid credit card of claim 13, further comprising the steps of reporting the monetary value of the generic prepaid credit card to the vendor of the generic prepaid credit card and reporting a monetary balance reduction of the gift card to the gift card vendor.
